(19) United States
(12) Patent Application Publication
(10) Pub. No.: US 2026/0267197 A1
(43) Pub. Date: Sep. 10, 2026

(54) MATERIALS FOR TEMPERATURE-ACTUATED OPTICAL SWITCHING AT INFRARED WAVELENGTHS

(71) Applicant: SRI INTERNATIONAL, Menlo Park, CA (US)

(72) Inventors: Brian SLOVICK, San Mateo, CA (US); Steven CROUCH-BAKER, Palo Alto, CA (US); Eric LAVELLE, San Jose, CA (US)

(21) Appl. No.: 19/166,951

(22) PCT Filed: Mar. 21, 2024
(86) PCT No.: PCT/US2024/020980

§ 371 Date: Sep. 19, 2025

Related U.S. Application Data
(60) Provisional application No. 63/454,579, filed on Mar. 24, 2023.

(51) Int. Cl. G02F 1/355; G02F 1/05; G02F 1/31

(52) U.S. Cl. CPC G02F 1/3551; G02F 1/05; G02F 1/31; G02F 2203/11

(57) ABSTRACT

Disclosed is a temperature-actuated optical switch comprising a. material having a ferroelectric to paraelectric transition at a Curie temperature, wherein the material has a first transmissivity to infrared light below the Curie temperature and has a second transmissivity to the infrared light above the Curie temperature, and wherein the second transmissivity is higher than the first transmissivity. Also disclosed are optical systems that comprise such a temperature-actuated optical switch and methods for using such a temperature-actuated optical switch.

### CROSS-REFERENCE TO RELATED APPLICATIONS

This application claims the benefit of U.S. Provisional Patent Application No. 63/454,579, filed Mar. 24, 2023, which is incorporated herein by reference in its entirety.

### BACKGROUND

Conventional materials that are used for windows at infrared wavelengths, such as medium-wave infrared (MWIR) and long-wave infrared (LWIR) wavelengths, include, for example, sapphire and zinc sulfide (ZnS). Such materials, however, have emissivities that increase with increasing temperature and transmissivities that decrease with increasing temperature. The increasing emissivity and decreasing transmissivity with increasing temperature make such conventional materials disadvantageous for high temperature applications (e.g., temperatures greater than 100° C. or temperatures greater than 1000° C., depending on the application). Accordingly, there is a need for materials that have emissivities that are sufficiently low and/or transmissivities that are sufficiently high at such high temperatures, so as to enable the materials to be suitable for use as infrared windows in high temperature applications.

### SUMMARY

Disclosed herein are materials having a ferroelectric to paraelectric transition at a Curie temperature that exhibit a higher infrared transmissivity (e.g., at MWIR wavelengths) above the Curie temperature than below the Curie temperature. This higher transmissivity at higher temperatures can support high temperature applications of such materials.

In a first example implementation, a temperature-actuated optical switch is provided. The temperature-actuated optical switch comprises a material having a ferroelectric to paraelectric transition at a Curie temperature, wherein the material has a first transmissivity to infrared light below the Curie temperature and has a second transmissivity to the infrared light above the Curie temperature, and wherein the second transmissivity is higher than the first transmissivity.

In some examples of the first example implementation, the material comprises barium titanate.

In some examples of the first example implementation, the infrared light comprises mid-wave infrared light having a wavelength between about 3 μm and about 5 μm.

In some examples of the first example implementation, the material has a domain structure comprising ferroelectric domains in a particular orientation when the material is below the Curie temperature. For example, the domain structure may comprise ferroelectric domains that are predominantly perpendicular to crystal edges. The domain structure could be established by subjecting the material to a plurality of temperature cycles, wherein each temperature cycle comprises heating the material to a temperature above the Curie temperature followed by cooling the material to a temperature below the Curie temperature. Alternatively, the domain structure could be established by applying a poling voltage to the material while heating the material to a temperature above the Curie temperature and then cooling the material to a temperature below the Curie temperature.

In a second example implementation, an optical system is provided. The optical system comprises the temperature-actuated optical switch of the first example implementation and an infrared sensor. The infrared sensor is optically coupled to the material and is configured to detect the infrared light.

In some examples of the second example implementation, the infrared sensor is an infrared imaging sensor.

In some examples of the second example implementation, the optical system further comprises a lock-in amplifier coupled to an output of the infrared sensor. The lock-in amplifier could be referenced to a modulation (e.g., a temperature modulation) applied to the material.

In a third example implementation, a method is provided. The method comprises exposing a temperature-actuated optical switch to infrared light, wherein the temperature-actuated optical switch comprises a material having a ferroelectric to paraelectric transition at a Curie temperature, wherein the material has a first transmissivity to the infrared light below the Curie temperature and has a second transmissivity to the infrared light above the Curie temperature, and wherein the second transmissivity is higher than the first transmissivity. The method further comprises detecting, by an infrared sensor, the infrared light transmitted through the temperature-actuated optical switch when the material has the first transmissivity and detecting, by the infrared sensor, the infrared light transmitted through the temperature-actuated optical switch when the material has the second transmissivity.

In some examples of the third example implementation, the material comprises barium titanate.

In some examples of the third example implementation, the infrared light comprises mid-wave infrared light having a wavelength between about 3 μm and about 5 μm.

In some examples of the third example implementation, the infrared sensor is an infrared imaging sensor.

In some examples of the third example implementation, the material has a domain structure comprising ferroelectric domains in a particular orientation when the material is below the Curie temperature. For example, the domain structure may comprise ferroelectric domains that are predominantly perpendicular to crystal edges. The domain structure could be established by subjecting the material to a plurality of temperature cycles, wherein each temperature cycle comprises heating the material to a temperature above the Curie temperature followed by cooling the material to a temperature below the Curie temperature. Alternatively, the domain structure could be established by applying a poling voltage to the material while heating the material to a temperature above the Curie temperature and then cooling the material to a temperature below the Curie temperature.

In some examples of the third example implementation, the method further comprises applying a modulation to the material, wherein the modulation causes the transmissivity of the material to vary between the first transmissivity and the second transmissivity. In some such examples, the modulation may comprise a temperature modulation. In addition, the modulation could be used as a reference by a lock-in amplifier that is coupled to an output of the infrared sensor. For example, the lock-in amplifier referenced to the modulation may amplify an output signal generated by the infrared sensor.

These implementations as well as other implementations, aspects, and applications, will become apparent to those of ordinary skill in the art by reading the following detailed description, with reference where appropriate to the accompanying drawings.

### BRIEF DESCRIPTION OF THE DRAWINGS

FIG. 1 is a graph showing a variation of transmissivity (solid line) at a wavelength of 4.05 μm of a BTO crystal and the temperature (dashed line) of the BTO crystal as a function of time in a first data set.

FIG. 2 is a graph showing a variation of transmissivity (solid line) at a wavelength of 4.05 μm of the BTO crystal and the temperature (dashed line) of the BTO crystal as a function of time in a second data set that was taken after the first data set.

FIG. 3 is a graph showing a variation of transmissivity (solid line) at a wavelength of 4.05 μm of the BTO crystal and the temperature (dashed line) of the BTO crystal as a function of time in a third data set that was taken after the second data set.

FIG. 4 is a graph showing a variation of transmissivity (solid line) at a wavelength of 4.05 μm of the BTO crystal and the temperature (dashed line) of the BTO crystal as a function of time in a fourth data set that was taken after the third data set.

FIG. 5A is a graph showing the variation of transmissivity (solid line) at a wavelength of 4.05 μm of the BTO crystal and the temperature (dashed line) of the BTO crystal as a function of time in a portion of the third data set shown in FIG. 3.

FIG. 5B is a graph showing the variation of transmissivity (solid line) at a wavelength of 4.05 μm of the BTO crystal and the temperature (dashed line) of the BTO crystal as a function of time in a portion of the fourth data set shown in FIG. 4.

FIG. 6 is a graph showing a variation of transmissivity (solid line) at a wavelength of 4.05 μm of the BTO crystal and the temperature (dashed line) of the BTO crystal as a function of time, using the heating system shown in FIG. 12.

FIG. 7 are images of the domain structure of an as-received BTO crystal. The images are 5.1 mm×4.1 mm in size.

FIG. 8 are images of the domain structure of the BTO crystal shown in FIG. 7 after the first thermal cycle (the thermal cycle illustrated in FIG. 1). The images are 1.3 mm×1.0 mm in size.

FIG. 9A are images of the domain structure of the BTO crystal shown in FIG. 7 after the second thermal cycle (the thermal cycle illustrated in FIG. 2). The left and center images are 5.1 mm×4.1 mm in size. The right image is 1.3 mm×1.0 mm in size.

FIG. 9B are images of the domain structure of the BTO crystal shown in FIG. 7 after the third thermal cycle (the thermal cycle illustrated in FIG. 3). The images are 5.1 mm×4.1 mm in size.

FIG. 10A are images of the domain structure of the BTO crystal shown in FIG. 7 after the fourth thermal cycle (the thermal cycle illustrated in FIG. 4). The left and center images are 5.1 mm×4.1 mm in size. The right image is 1.3 mm×1.0 mm in size.

FIG. 10B are images of the domain structure of a BTO crystal before (left) and after (right) electrical poling using the apparatus illustrated in FIG. 13. Both images are 5.1 mm×4.1 mm in size.

FIG. 11 schematically illustrates a system for optical characterization of BTO samples mounted in a tube furnace, in accordance with an example embodiment.

FIG. 12 schematically illustrates a heating system that includes a ceramic heater for heating a BTO crystal, in accordance with an example embodiment.

FIG. 13 schematically illustrates an apparatus used for electrically poling a BTO crystal.

FIG. 14A schematically illustrates a temperature-actuated optical switch operating at a temperature below the Curie temperature, in accordance with an example embodiment.

FIG. 14B schematically illustrates a temperature-actuated optical switch operating at a temperature above the Curie temperature, in accordance with an example embodiment.

FIG. 15 schematically illustrates an optical system that includes a temperature-actuated optical switch, an infrared sensor, a modulation source, and a lock-in amplifier, in accordance with an example embodiment.

FIG. 16 is a flow chart illustrating a method for using a temperature-actuated optical switch, in accordance with an example embodiment.

### DETAILED DESCRIPTION

This disclosure describes inventive concepts with reference to specific examples. However, the intent is to cover all modifications, equivalents, and alternatives of the inventive concepts that are consistent with this disclosure. It will be apparent, however, to one of ordinary skill in the art that the present approach can be practiced without these specific details. Thus, the specific details set forth are merely exemplary, and is not intended to limit what is presently disclosed. The features implemented in one embodiment may be implemented in another embodiment where logically possible. The specific details can be varied from and still be contemplated to be within the spirit and scope of what is being disclosed.

Disclosed herein are materials with a ferroelectric to paraelectric transition at a Curie temperature that have a reduced infrared emission and increased infrared transmission above the Curie temperature. Such materials are suitable for high temperature infrared windows and other high temperature optical applications.

From a theoretical perspective, certain paraelectric materials are predicted to achieve very low infrared self-emission at high temperature due to the coincidence of their high and low frequency dielectric functions, which lowers the oscillator strength of the deleterious infrared emission processes.

From an experimental perspective, disclosed herein are optical studies on barium titanate (“BTO”) crystals as an example material having a ferroelectric to paraelectric transition. Those studies revealed anomalous MWIR transmittance behavior as the temperature is varied through the Curie transition. To further characterize and determine the utility of the optical anomaly, the MWIR and visible, domain-related properties of BTO crystals on temperature cycling in the vicinity of their Curie temperature (approximately 130° C.) were characterized. Those studies support the use of BTO (and other materials having a ferroelectric to paraelectric transition) as a temperature-actuated optical switch, as well as other applications.

Also disclosed herein are studies on the use of thermal treatments and electrical poling to control the ferroelectric domain structure that occurs in BTO below the Curie temperature. Such treatments have been found to be beneficial for the temperature-actuated control of the transmissivity of BTO. In particular, to further characterize the above phenomenon with controlling the domain behavior in the low temperature, ferroelectric phase, and its evolution at the Curie temperature, in concert with MWIR transmittance variations, the following studies were performed.

The MWIR transmissivity (at 4.05 μm and up to approximately 200° C.) of BTO of known domain structure using two different heating methods was measured. A demonstration of repeatable transmission variation on temperature cycling was obtained using crystals that had undergone temperature cycling pretreatment.

Visible microscopic observation of the evolution of the domain structure of BTO on temperature cycling through the Curie temperature in concert with infrared transmission measurements was made. Following temperature cycling, broadly reproducible domain structures were obtained that can underpin repeatable infrared transmission variations.

The domain structure adopted on electrical poling of thin, disc shaped BTO crystals of defined ferroelectric axis orientation was determined by visible microscopy. It was shown that the resulting domain structure corresponds to that adopted on temperature cycling of as-received BTO crystals.

These studies demonstrate that BTO (and other materials having a ferroelectric to paraelectric transition) are useful in applications, such as IR imaging and IR windows, that can benefit from the large increase in IR transmission at the Curie temperature. For an IR window, one could select a material with a Curie temperature that is below the temperatures to which the IR window is exposed, so as to take advantage of the enhanced IR transmissivity above the Curie temperature. The variation of IR transmissivity around the Curie temperature also supports the use of such materials as a temperature-actuated optical switch, for IR imaging or other applications. For example, the transmissivity of the window material could be thermally modulated, with the modulation used as a phase reference by a lock-in amplifier to increase the signal to noise ratio of the output of an IR imager or other IR sensor.

1. Example Optical Studies of Transmissivity Variation with Temperature

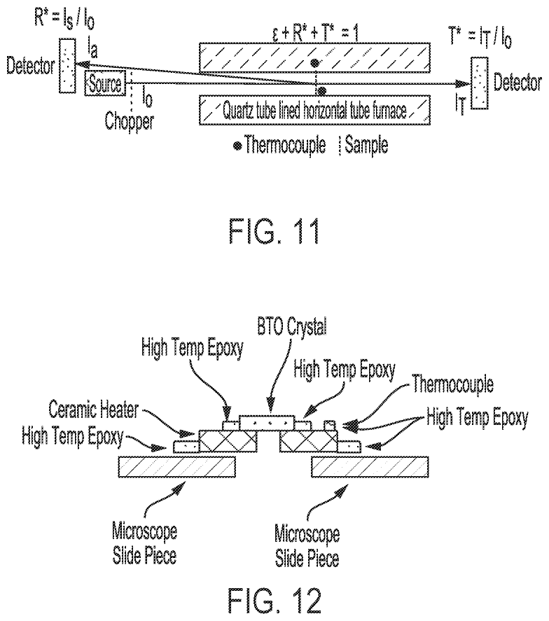

To characterize the evolution on thermal cycling of the transmissivities of purchased, unpoled, (100) oriented single-crystal slabs of BTO (1 cm²×1 mm), two different heating systems were employed. For the optical characterization of purchased thin, plane-parallel samples of BTO on heating, subject to substantially normal incidence of radiation at the chosen wavelength, the set-up shown in FIG. 11 was employed. Vertically oriented samples were mounted inside a furnace (Lindberg/Blue M, HTF55347C) within a horizontally oriented quartz tube (diameter: 60 mm) and irradiated with 4.05 μm MWIR light generated using a well-collimated laser (Thorlabs QCL, QF4050CM1). The source was modulated via a mechanical chopper wheel (Stanford Research Systems, SR-540, chopped at ~158 Hz) to aid in distinguishing the desired signal from the infrared background. Samples were held in a mount machined from a bar of Macor® high temperature glass-ceramic with slots to hold samples of various thicknesses as well as a thermocouple to monitor the sample temperature. A liquid nitrogen cooled mercury-cadmium-telluride detector (Daylight Solutions, HPC-2TE-100 with a lock-in amplifier, Stanford Research Systems SR-830) in combination with a gold integrating sphere was used to monitor the transmitted signal. The signal from the lock-in amplifier, as well as a voltage signal scaled for temperature measurements from a commercial temperature controller, were collected using an NI 9219 module and a Labview data collection routine.

A second heating system was employed that used a ceramic heater to heat one side of an attached BTO crystal. An alternative to furnace heating of BTO crystals was achieved using the design shown in FIG. 12. Microscope slide pieces acting as a structural support were bonded to a 19W ring-shaped, ceramic heater (Thorlabs, Part Number HT19) using high temperature epoxy (Thorlabs, part number 353NDPK) as shown in FIG. 12. The BTO crystal and a thermocouple were then similarly attached to the heater. The heater and thermocouple wires were soldered to a custom cable for connection with the temperature controller, then strain relieved with Kapton tape to the slide glass. The epoxy was cured at 100° C. The heater unit was secured to a vertically oriented rotation mount for infrared transmission studies using the same optical system as for furnace heating. Similarly, the heater unit was transferred to a microscope visible, domain studies. In this approach, the same crystal can be transferred immediately following infrared characterization over a given thermal cycle to a microscope for real-time, video imaging of the domain structure over the same cycle, as described below.

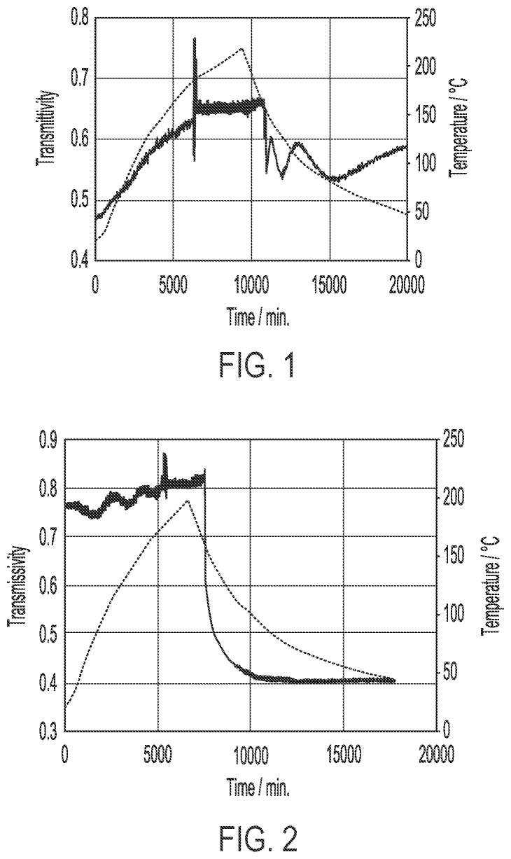

FIGS. 1-4 show the variations of the transmissivity as a function of temperature for a single 1 mm thick, unpoled, (100) oriented single-crystal slab of BTO on repeated heating and subsequent cooling at a wavelength of 4.05 μm using the furnace heater. Both transmissivity and temperature are plotted as a function of time.

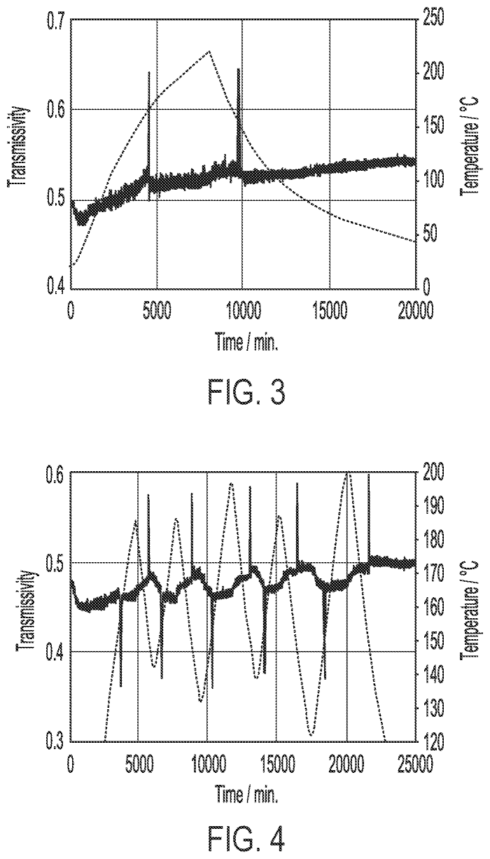

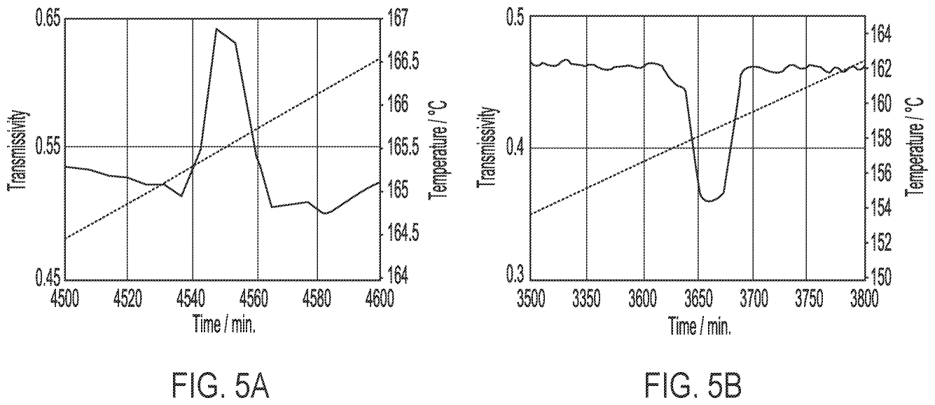

It is evident that initial temperature cycling, as shown in FIGS. 1-3, reveals varied and inconsistent infrared transmissivity behavior on both heating and cooling at approximately 150° C., apparently somewhat above the conventional Curie temperature. FIG. 4 shows different, but repeatable transmissivity variations at the same temperature on faster heating and cooling. The transmissivity transients shown in FIGS. 3 and 4 occur over a relatively narrow temperature range but are delineated by several data points according to the frequency of data acquisition employed. FIGS. 5A and 5B illustrate this with detailed data from FIGS. 3 and 4, respectively.

It was determined that the placement of the temperature sensor led to a higher recorded sample temperature than was the case, by approximately 20° C. Thus, the transmission variations shown in FIGS. 1, 2, 3, 4, 5A, and 5B did in fact occur around the Curie temperature. In the ceramic heater design, this temperature offset did not occur.

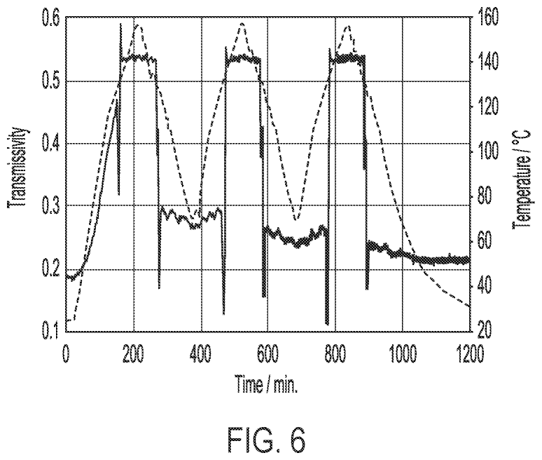

FIG. 6 shows the variations of the transmissivity and temperature as a function of time for a 1 mm thick BTO crystal using the ceramic heater set-up shown in FIG. 12. Prior to infrared measurement, the crystal was subjected to four temperature/time cycles of the type shown in FIG. 6 to avoid the irreproducible transmissivity behaviour obtained in the initial furnace runs described above. As shown in FIG. 6, systematic variations in transmissivity occurred at approximately 130° C., i.e., the Curie temperature. This data supports the use of the material as a temperature-actuated optical switch having a higher transmissivity above the Curie temperature and a lower transmissivity below the Curie temperature.

### 2. Example Studies of the Effects of Temperature Cycling on the Ferroelectric Domain Structure in BTO

To characterize the evolution of BTO ferroelectric domain structure on thermal cycling, visible still images and video measurements were made (using a Zeiss AXIO Observer.A.1, an inverted, transmission microscope) of the BTO crystals used for the infrared transmission studies reported in FIGS. 1-6. Only brightfield imagery was taken.

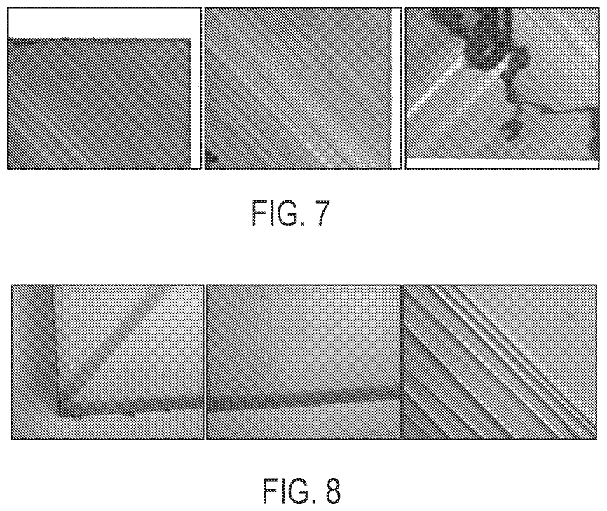

Prior to the first thermal cycle shown in FIG. 1 above, the ferroelectric domain structure in the as-received crystal was determined, as shown in FIG. 7. This material, in common with all the as-received crystals showed a characteristic pattern in which domains are oriented at 45° to the edges of the crystal. In addition, some macroscopic twinned regions were evident (FIG. 7, right), but always with a 45° pattern. These domains are referred to as “a” domains.

After the first thermal cycle, as shown in FIG. 1, a different domain structure can be seen, in which the domains are oriented perpendicular to the crystal edges, as shown in FIG. 8. These domains are referred to as “c” domains.

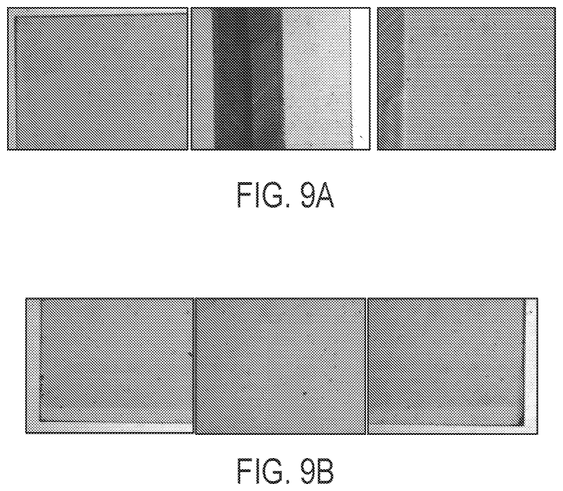

After the second thermal cycle, as shown in FIG. 2, the crystal largely retains the “c” domain structure, as shown in FIG. 9A. However, one twinned region with “a” domains was detected, as shown in the center and right images of FIG. 9A.

After the third thermal cycle, as shown in FIG. 3, the crystal had largely adopted the “c” domain pattern, as shown in FIG. 9B.

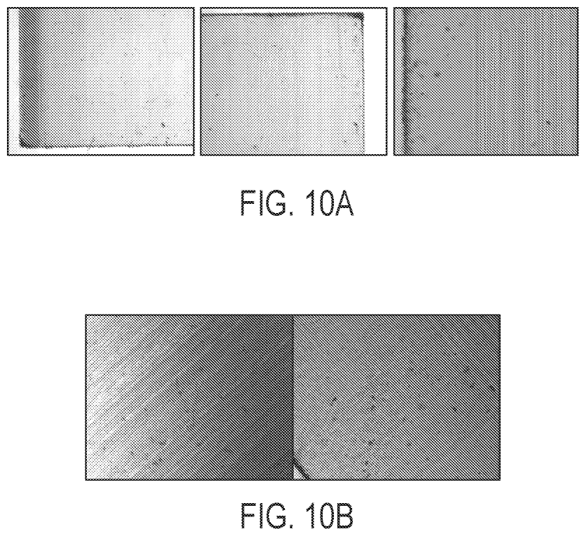

After the fourth thermal cycle, as shown in FIG. 4, the crystal again largely retained the “c” domain pattern, as shown in FIG. 10A.

Immediately following the transmission measurements shown in FIG. 6, the domain evolution on further cycling using the same temperature/time protocol as shown in FIG. 6 was video recorded using the microscope. In a first run, using the ceramic heater shown in FIG. 12, a region of the BTO crystal (4 mm in diameter) that exhibited both “a” and “c” domains was studied. It was found that the “a” domains are less transmissive in visible light than the “c” domains. On reaching the Curie temperature, most of the domains vanish in the paraelectric phase although one region appeared to retain its “c” domains well above the Curie temperature (and for the duration of the entire experiment). While this is not presently understood, the crystal is heated asymmetrically and is bonded rigidly to the heater, which may introduce stress-related effects. On cooling, a mixed domain structure is observed with, significantly, the “a” domains occupying the same region as at the beginning. In a second run immediately following the first run and again using the ceramic heater shown in FIG. 12, the BTO crystal was studied in the same way, with substantially the same results.

### 3. Example Studies on the Effects of Electrical Poling on the Ferroelectric Domain Structure in BTO

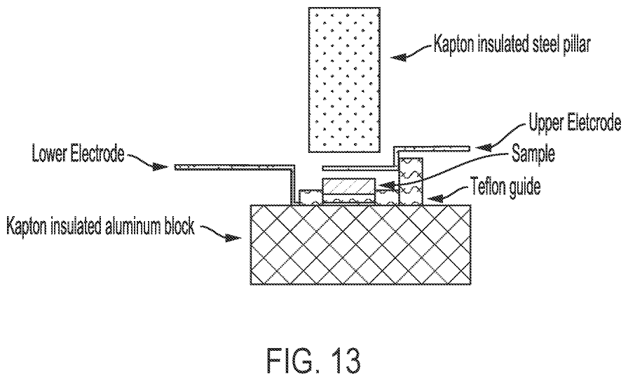

Electrical poling of an as-received BTO crystal (0.5 mm thick) was performed using the apparatus and conditions described herein. Application of a D.C. electric field to BTO, typically about 10 kVcm⁻¹, at elevated temperature encourages alignment of the domain c-axes with the field in a process referred to as “poling.” An apparatus was constructed as shown in FIG. 13, for BTO crystal poling. The apparatus included a base made from an aluminum block for its thermal mass and stability. The block was covered in Kapton® polyimide to insulate the block from the poling voltages. A lower electrode, made of either a thin silver strip or a TiW-coated glass slide, was secured to the block with a small amount of Kapton® tape. A guide made of Teflon® fluoroploymer was used to locate the crystal above the lower electrode. Another, slightly larger piece, of Teflon® fluoroploymer was used to hold the upper electrode above the sample.

The electrodes and sample were brought into intimate contact using the weight of a steel pillar insulated with Kapton® polyimide. The entire apparatus was mounted in an oven. A high voltage supply was connected to the electrodes via a high temperature cable feed (rated to 440° C.) through an insulated inlet in the oven. Once the oven is scaled, the voltage was applied to the electrodes, and the oven was turned on. Two poling voltage sources can be used: (i) A PS310 unit capable of supplying 1250 volts at 25 Watts, and (ii) A PS325 unit that can supply 2500 volts at 25 Watts. The oven was set to above the Curie temperatures (~160° C.) while the poling voltage is applied. After a predetermined time at the set temperature, the oven was turned off and allowed to cool slowly to room temperature, while poling voltage is maintained. Once room temperature is reached, the poling voltage is removed.

In one embodiment, poling can be assessed using microscopic examination under polarized light and capacitance measurement. In another embodiment, 0.5 and 1 mm thick COTS BTO crystals can be poled and tested for their transmission response in the vicinity of the Curie temperature over the entire infrared wavelength band. FIG. 10B illustrates the change in domain structure that can be achieved using electrical poling. We conclude that, concerning the crystal microstructure, the result of electrical poling is the same as that of thermal poling.

The studies described above show that reproducible infrared transmission variations on temperature cycling of BTO through the Curie temperature can be observed, provided that the BTO crystal has a reproducible ferroelectric domain structure in the BTO crystal (e.g., a ferroelectric domain structure established by thermal cycling). Prior to the establishment of a reproducible domain structure in the BTO crystal, the infrared properties observed on temperature cycling are highly variable. In one embodiment, a suitable domain structure for BTO consists largely of “c” domains, although some regions containing “a” domains can be present. However, while this domain structure was found to be suitable for BTO with a (100) crystal orientation, it is to be understood that some other type of domain structure may be suitable to achieve the desired temperature variation of infrared transmissivity for a BTO crystal with a different orientation.

In one approach, a suitable domain structure for BTO can be achieved by thermal cycling. The thermal cycling can involve heating the BTO crystal to a temperature above the Curie temperature followed by cooling the BTO crystal to a temperature below the Curie temperature and repeating this multiple times (e.g., two times, three times, four times, or some other number of times). In another approach, a suitable domain structure can be achieved by electrical poling. The electrical poling can involve applying a poling voltage to the BTO crystal while heating the BTO to a temperature above the Curie temperature and then maintaining the poling voltage while cooling the BTO to a temperature below the Curie temperature.

### 4. Example Applications

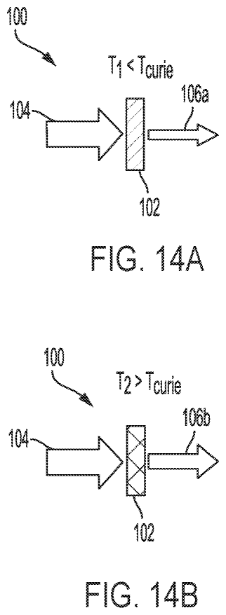

The variation in infrared transmissivity with temperature that was observed in BTO, as described above, can be used in various applications in which it is beneficial for an optical window or other optical element to have a transmissivity that varies with temperature. One such application is a temperature-actuated optical switch, for example, as illustrated in FIGS. 14A and 14B.

FIGS. 14A and 14B show a temperature-actuated optical switch 100 that includes an optical element 102. The optical element 102 could be, for example, an optical window, a lens, a prism, or other element that at least partially transmits light. As shown in FIGS. 14A and 14B, infrared light 104 is incident on optical element 102. Infrared light 104 could be any light in the infrared region of the electromagnetic spectrum. In one example, infrared light 104 comprises mid-wave infrared (MWIR) light having a wavelength between about 3 μm and about 5 μm. For example, the wavelength could be 4.05 μm, as in the studies described above. The optical element 102 is made of a material having a ferroelectric to paraelectric transition at a Curie temperature, wherein the material has a first transmissivity to the infrared light 104 below the Curie temperature and a second transmissivity to the infrared light 104 above the Curie temperature, with the second transmissivity being higher than the first transmissivity. In one example, the material comprises barium titanate. Other candidate materials include, without limitation: lithium tantalate; lithium niobate; lead zirconate titanate; and lead titanate.

FIG. 14A illustrates a scenario in which the optical element 102 is at a first temperature (T₁) that is below the Curie temperature (T_{Curie}), as indicated by the text “T₁<T_{Curie}” in that drawing. In this scenario, the optical element 102 has a first transmissivity such that a portion of infrared light 104 is transmitted through the optical element 102 as transmitted infrared light 106a. The first transmissivity is substantially less than one, as suggested by the width of the arrow symbol for transmitted infrared light 106a being much less than the width of the arrow symbol for infrared light 104. In some embodiments, the first transmissivity could be less than 0.5 or less than 0.3, for example.

FIG. 14B illustrates a scenario in which the optical element 102 is at a second temperature (T₂) that is above the Curie temperature (T_{Curie}), as indicated by the text “T₂>T_{Curie}” in that drawing. In this scenario, the optical element 102 has a second transmissivity such that a portion of infrared light 104 is transmitted through the optical element 102 as transmitted infrared light 106b. The second transmissivity is greater than the first transmissivity, as suggested by the width of the arrow symbol for transmitted infrared light 106b being greater than the width of the arrow symbol for transmitted infrared light 106a. In some embodiments, the second transmissivity could be greater than 0.5, for example.

In some embodiments, the temperature-actuated optical switch 100 shown in FIGS. 14A and 14B could be part of an optical system that includes other components that may include, for example, one or more infrared light sources, one or more mirrors or other reflective elements, one or more lenses or other refractive elements, one or more infrared sensors and associated circuitry, as well as means to control the temperature of optical switch 100 and thereby achieve a desired variation in infrared transmissivity with temperature.

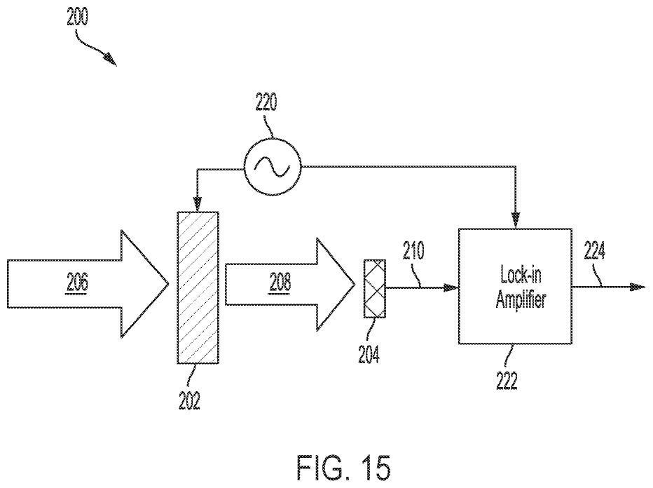

FIG. 15 illustrates an example optical system 200 in which an optical element 202 is optically coupled to an infrared sensor 204. Incident infrared light 206 is incident on the optical element 202, and a portion of the incident infrared light 206 is transmitted through the optical element as transmitted infrared light 208. The infrared sensor 204 is configured to detect the transmitted infrared light 208 to generate an output signal 210. The infrared sensor 204 may include, for example, a mercury cadmium telluride (HgCdTe) detector, a lead selenide (PbSe) detector, an indium antimonide (InSb) detector, or other type of detector, depending on the wavelengths of the incident infrared light 206 to be detected. The infrared sensor 204 may also include one or more lenses, cryogenic cooling systems, or other components.

The output signal 210 is indicative of one or more characteristics of the incident infrared light 206, such as temporal-variations and/or spatial-variations in the incident infrared light 206. For example, the infrared sensor 204 could be an imaging sensor configured to generate an image indicative of the incident infrared light 206.

The optical element 202 functions as a temperature-actuated optical switch and is similar to the optical element 102 illustrated in FIGS. 14A and 14B. Thus, the optical element 202 is made of a material having a ferroelectric to paraelectric transition at a Curie temperature, wherein the material has a first transmissivity to the incident infrared light 206 below the Curie temperature and a second transmissivity to the incident infrared light 206 above the Curie temperature, with the second transmissivity being higher than the first transmissivity. For example, optical element 202 may comprise barium titanate.

The variation of transmissivity with temperature that is exhibited by optical element 202 can be used to improve the signal-to-noise ratio of the output signal 210. To achieve this, the optical system 200 may include a modulation source 220 and a lock-in amplifier 222.

The modulation source 220 may be any signal source that is configured to apply a modulation to optical element 202 that causes a time variation in the transmissivity of optical element 202. For example, modulation source 220 may apply a thermal modulation to optical element 202. To achieve this, modulation source 220 may be coupled to one or more heaters that are integrated into optical element 202, coupled to optical element 202, or arranged to heat optical element 202 indirectly. The modulation source 220 may apply a modulation signal to the one or more heaters that causes the temperature of the optical element 202 to vary between a temperature below the Curie temperature, such that the optical element 202 has a relatively lower transmissivity, and a temperature above the Curie temperature, such that the optical element 202 has a relatively higher transmissivity.

The lock-in amplifier 222 may be referenced to the modulation applied by the modulation source 220 such that the lock-in amplifier 222 selects and amplifies a component of the output signal 210 that is in phase with the modulation. In this way, the lock-in amplifier 222 can provide an enhanced output signal 224 that has a higher signal-to-noise ratio than that of output signal 210.

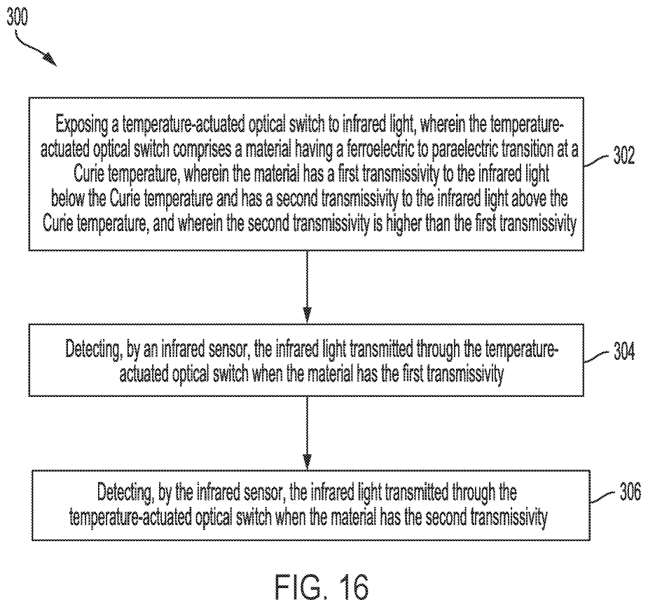

FIG. 16 is a flow chart illustrating an example method 300 for using a temperature-actuated optical switch. The method 300 involves exposing a temperature-actuated optical switch to infrared light, wherein the temperature-actuated optical switch comprises a material having a ferroelectric to paraelectric transition at a Curie temperature, wherein the material has a first transmissivity to the infrared light below the Curie temperature and has a second transmissivity to the infrared light above the Curie temperature, and wherein the second transmissivity is higher than the first transmissivity (block 302). The temperature-actuated optical switch could include an optical element similar to optical element 102 or optical element 202 described above. Thus, the material could be barium titanate and could have a domain structure comprising ferroelectric domains in a particular orientation when the material is below the Curie temperature. The domain structure could be established by subjecting the material to a plurality of temperature cycles, wherein each temperature cycle comprises heating the material to a temperature above the Curie temperature followed by cooling the material to a temperature below the Curie temperature. Alternatively, the domain structure could be established by applying a poling voltage to the material while heating the material to a temperature above the Curie temperature and then cooling the material to a temperature below the Curie temperature.

In example embodiments, exposing the temperature-actuated optical switch to infrared light may involve arranging the temperature-actuated optical to receive infrared light from a particular environment, such as a terrestrial environment, an aerial environment, or a space environment. For example, the temperature-actuated optical switch on a vehicle that is traveling through the particular environment.

The method 300 further involves detecting, by an infrared sensor, the infrared light transmitted through the temperature-actuated optical switch when the material has the first transmissivity (block 304). The method 300 additionally involves detecting, by the infrared sensor, the infrared light transmitted through the temperature-actuated optical switch when the material has the second transmissivity (block 306). The infrared sensor could be similar to infrared sensor 204 described above.

In some embodiments, the method 300 also involves applying a modulation to the material. The modulation causes the transmissivity of the material to vary between the first transmissivity and the second transmissivity. For example, the modulation may comprise a temperature modulation. With a modulation being applied to the material, the method 300 may additionally involve amplifying, by a lock-in amplifier, an output signal generated by the infrared sensor, wherein the lock-in amplifier is referenced to the modulation. In this way, the lock-in amplifier can provide an enhanced output signal that has a higher signal-to-noise ratio than that of the output signal generated by the infrared sensor.

The foregoing system and embodiments thereof have been provided in sufficient detail, but it is not the intention of the applicant(s) for the disclosed system and embodiments provided herein to be limiting. Additional adaptations and/or modifications are possible, and, in broader aspects, these adaptations and/or modifications are also encompassed. Accordingly, departures may be made from the foregoing system and embodiments without departing from the spirit of the system.

1. A temperature-actuated optical switch, comprising:
a material having a ferroelectric to paraelectric transition at a Curie temperature, wherein the material has a first transmissivity to infrared light below the Curie temperature and has a second transmissivity to the infrared light above the Curie temperature, and wherein the second transmissivity is higher than the first transmissivity.

2. The temperature-actuated optical switch of claim 1, wherein the material comprises barium titanate.

3. The temperature-actuated optical switch of claim 1, wherein the material has a domain structure comprising ferroelectric domains in a particular orientation when the material is below the Curie temperature.

4. The temperature-actuated optical switch of claim 3, wherein the domain structure is established by subjecting the material to a plurality of temperature cycles, wherein each temperature cycle comprises heating the material to a temperature above the Curie temperature followed by cooling the material to a temperature below the Curie temperature.

5. The temperature-actuated optical switch of claim 3, wherein the domain structure is established by applying a poling voltage to the material while heating the material to a temperature above the Curie temperature and then cooling the material to a temperature below the Curie temperature.

6. The temperature-actuated optical switch of claim 3, wherein the domain structure comprises ferroelectric domains that are predominantly perpendicular to crystal edges.

7. The temperature-actuated optical switch of claim 1, wherein the infrared light comprises mid-wave infrared light having a wavelength between about 3 μm and about 5 μm.

8. An optical system comprising:
a temperature-actuated optical switch comprising a material having a ferroelectric to paraelectric transition at a Curie temperature, wherein the material has a first transmissivity to infrared light below the Curie temperature and has a second transmissivity to the infrared light above the Curie temperature, and wherein the second transmissivity is higher than the first transmissivity; and
an infrared sensor optically coupled to the material, wherein the infrared sensor is configured to detect the infrared light.

9. The optical system of claim 8, further comprising a lock-in amplifier coupled to an output of the infrared sensor.

10. The optical system of claim 9, wherein the lock-in amplifier is referenced to a modulation applied to the material.

11. The optical system of claim 10, wherein the modulation applied to the material comprises a temperature modulation.

12. The optical system of claim 8, wherein the infrared sensor is an infrared imaging sensor.

13. A method comprising:
exposing a temperature-actuated optical switch to infrared light, wherein the temperature-actuated optical switch comprises a material having a ferroelectric to paraelectric transition at a Curie temperature, wherein the material has a first transmissivity to the infrared light below the Curie temperature and has a second transmissivity to the infrared light above the Curie temperature, and wherein the second transmissivity is higher than the first transmissivity;
detecting, by an infrared sensor, the infrared light transmitted through the temperature-actuated optical switch when the material has the first transmissivity; and
detecting, by the infrared sensor, the infrared light transmitted through the temperature-actuated optical switch when the material has the second transmissivity.

14. The method of claim 13, wherein the material comprises barium titanate.

15. The method of claim 13, wherein the material has a domain structure comprising ferroelectric domains in a particular orientation when the material is below the Curie temperature.

16. The method of claim 15, wherein the domain structure is established by subjecting the material to a plurality of temperature cycles, wherein each temperature cycle comprises heating the material to a temperature above the Curie temperature followed by cooling the material to a temperature below the Curie temperature.

17. The method of claim 15, wherein the domain structure is established by applying a poling voltage to the material while heating the material to a temperature above the Curie temperature and then cooling the material to a temperature below the Curie temperature.

18. The method of claim 13, further comprising:
applying a modulation to the material, wherein the modulation causes the transmissivity of the material to vary between the first transmissivity and the second transmissivity.

19. The method of claim 18, wherein the modulation comprises a temperature modulation.

20. The method of claim 18, further comprising:
amplifying, by a lock-in amplifier, an output signal generated by the infrared sensor, wherein the lock-in amplifier is referenced to the modulation.
